(19) United States
(12) Patent Application Publication
(10) Pub. No.: US 2023/0408029 A1
(43) Pub. Date: Dec. 21, 2023

(54) ENERGY AND HYDROGEN TRANSPORT SYSTEM

(71) Applicant: Manuel Munoz Saiz, Almeria (ES)

(72) Inventor: Manuel Munoz Saiz, Almeria (ES)

(21) Appl. No.: 18/362,473

(22) Filed: Jul. 31, 2023

Related U.S. Application Data
(63) Continuation of application No. PCT/ES2021/000044, filed on Dec. 22, 2021.

(30) Foreign Application Priority Data
Jan. 29, 2021 (ES) U202100044
Jul. 12, 2021 (ES) U202100302
Sep. 30, 2021 (ES) U202100368

(51) Int. Cl. F17C 1/04

(52) U.S. Cl. CPC F17C 1/04; F17C 2203/0604; F17C 2221/012; F17C 2203/0629

(57) ABSTRACT

An energy and hydrogen transport system includes a duct to transfer hydrogen. The duct has a pump or fan driven by an electric motor to pressurize or create a vacuum therein. A double walled container stores hydrogen.

### CROSS-REFERENCE TO RELATED APPLICATION

This application is a continuation, under 35 U.S.C. § 120, of co-pending International Patent Application PCT/ES2021/000044, filed Dec. 22, 2021, which designated the United States; this application also claims the priority, under 35 U.S.C. § 119, of Spanish Patent Applications
U202100044, filed Jan. 29, 2021,
U202100302, filed Jul. 12, 2021,
U202100368, filed Sep. 30, 2021;

the prior applications are herewith incorporated by reference in their entirety.

### FIELD AND BACKGROUND OF THE INVENTION

In energy transport systems and transfer of hydrogen gas. Hydrogen is used to generate electricity and in oil refineries to remove impurities, such as sulfur and olefins, from crude oil. The removal of these impurities produces less polluting gasoline and diesel, which is the fundamental requirement for modern internal combustion engines, allowing vehicle emissions to be reduced.

STATE OF THE ART—Hydrogen transport and transfer systems are complicated, expensive, dangerous and/or ineffective. The same happens with the transport of electrical energy. With the present invention such problems can be solved in a simple and economical way.

### SUMMARY OF THE INVENTION

Objective of the invention. Use a useful, practical, economical, simple, safe and leak-free system for the transfer of hydrogen gas.

To transport hydrogen through pipelines over long distances, without losses and economically.

With the foregoing and other objects in view there is provided, in accordance with the invention, an energy and hydrogen transport system that includes a duct to transfer hydrogen. The duct has a pump or fan driven by an electric motor to pressurize or create a vacuum therein. A double walled container stores hydrogen.

According to another aspect, the duct is single walled and the pump or fan is disposed at an extraction end of said duct for transporting the hydrogen with a pressure below atmospheric.

According to another aspect, the duct has two walls that define an intermediate chamber. The two walled duct is for hydrogen at pressures (p) of several atmospheres in said double walled container or in said two-walled duct. The intermediate chamber carries a fluid, oil mineral, nitrogen or noble gas at a pressure (p1) higher than the pressures of hydrogen in said two walled duct.

According to another aspect, the system has a conduit and the duct is a plurality of ducts disposed within said conduit. The conduit defines a chamber that contains a medium to surround said ducts. The medium has a pressure greater than the pressure of the hydrogen in said ducts.

According to another aspect, the double walled container is two double walled containers spaced apart from one another. The duct connects said two double walled containers to transport hydrogen therebetween.

According to another aspect, one of said double walled containers is a receiving container and hydrogen from said receiving container feeds a gas turbine to drive an electric generator or alternator for distribution of current to towns or industrial areas.

According to another aspect, the container is constructed as a carboy.

According to another aspect, the duct and double walled container are covered or lined with anticorrosive insulating layers.

According to another aspect, the duct and container are selected from steels or polymers, reinforced with carbon and glass fibers, sheets or crossed bands of Kevlar or carbon nanotubes, epoxy with aluminum plates, aluminized or blued.

According to another aspect, the materials for the container and duct are selected from carbon, austenitic, ferritic steels, steels with copper, brass, chromium and molybdenum alloys, copper bronze alloys with aluminum, tin, manganese, lead and silica, and with alloys of copper bronzes with nickel, or steels with microalloys.

To be able to substitute the transport of electrical energy for that of hydrogen gas using gas pipelines.

Being able to reuse current gas or oil pipelines for the transfer of hydrogen.

Take advantage of renewable energy transformed into green hydrogen, especially that obtained by photoelectrolysis, using transition metal oxides and sulfides. Where some photoelectrochemical cells transform solar radiation into electricity through photoactive anodes and cathodes. These are semiconductors capable of absorbing solar radiation and spontaneously promoting an electric current that circulates from the anode to the cathode, allowing water molecules to break on the anode surface, forming oxygen and protons, which travel through the electrolyte. toward the cathode to form hydrogen.

At the destination, hydrogen can be used to produce electricity with fuel cells, in turbines or internal combustion engines.

Hydrogen can be transported and even stored in double-walled containers or pipes, between which mineral oil, nitrogen or a noble or inert gas is used) pressurized at a higher pressure than the internal hydrogen. In this way it acts as a barrier preventing hydrogen from escaping.

Problem to solve. Hydrogen gas is very difficult to store and transport. Leaks occur due to the small size of the hydrogen molecule and the large differential pressure that exists across the vessel cover. There is no impermeable material that prevents the leakage of hydrogen between its molecules. This problem is solved with this system, being able to transfer it over long distances, like gas, through cheaper gas pipelines, less heavy and without leaks. The transport of electrical energy is expensive and inefficient, it has many losses, with the proposed transfer system the problem can be solved. For all of the above, this system is very ecological, especially if it is green hydrogen that is obtained with renewable energy.

The energy and hydrogen transport system includes pipes for its transfer and storage containers, which is characterized by the fact that the pipes have pumps, fans at their end or intermediate zone, which are driven by motors. electrical, producing a suction or pressurization of the conduit and because they have one or two walls and because the containers have two or three walls. The pressurized hydrogen can be found inside another conduit with a larger section that surrounds them. Between said conduits or between the containers and their casings or covers, a noble gas or nitrogen is applied at a higher pressure than that of the hydrogen in the conduits or containers. Said noble gas acts as a screen or impermeable preventing the hydrogen from escaping. Optionally, the inner walls of the ducts and even the outer ones can be covered with an additional waterproof layer.

Hydrogen can be transported in three ways:
a) With a single-walled conduit, hydrogen is transported inside with a pressure below atmospheric. It could be similar to or close to atmospheric.
b) With the duct with two walls, or with an intermediate chamber, higher pressures of several atmospheres can be used. In which case the intermediate chamber will carry a fluid (that does not react with hydrogen) with a pressure higher than that of hydrogen.
c) In a variant, two or more independent conduits are used, with the interiors floating, the chamber between them pressurized and the hydrogen flowing through the most internal conduits. This is also valid for containers. In this way the manufacture of the ducts is simpler.

Double or triple wall containers can be used as carboys in vehicles.

When the internal pressure of hydrogen is lower, it does not try or is not forced out of it. The wall does not allow the fluid to enter and mix with the hydrogen, which is at a lower pressure.

The intermediate chamber of the containers and conduits is filled with a mineral oil, nitrogen or a noble gas at a pressure higher than the one at which the hydrogen is to be transferred or stored. The walls can be kept apart by separating strips of thermal insulating material. The fluid used must not react with hydrogen.

You can use an infinite number of gas or oil pipelines that are currently in disuse, or whose current use could be changed. They would be used to transport hydrogen, energy and simultaneously, due to the fact that they are large pipelines or conduits, for storage until later use.

The transport of energy using hydrogen gas pipelines avoids the losses that occur with the current electric energy transport.

With this system there are no leaks, allowing the ducts to be simpler, lighter, safer and more economical, consistent and unaffected by corrosion materials can be used.

The ducts can be covered or lined with layers of insulating polymers that are resistant to corrosion and external atmospheric elements.

The casings of the ducts and containers can be made of special steels or polymers reinforced with carbon and glass fibers, sheets or crossed bands of Kevlar or carbon nanotubes and epoxy with aluminum plates, aluminized, blued, etc. Polyester or polyethylene is resistant to atmospheric agents. Polymers can be spray applied and conduits can be made by extrusion.

Carbon, austenitic, ferritic, etc., steels can be used for vessels and ducts. and steels with copper, brass, chrome and molybdenum alloys, with copper bronze alloys with aluminum, tin, manganese, lead, silica, etc., and with copper bronze alloys with nickel. Microalloyed steels are also useful.

It adds an independent emergency system by means of pressure switches, which, when detecting that there is no depression or pressure, as the case may be, inside the ducts, activate shut-off solenoid valves or pumps or turbines which provide a slight pressure or relative depression inside said ducts.

This system only works in the event of a stoppage of the system that produces the suction, but not in the event of a break in the ducts.

To transport energy, the hydrogen from the receiving tank or container feeds a gas turbine that drives an alternator or generator that distributes the current to towns or industrial zones. From this tank, the hydrogen directly feeds internal combustion engines or fuel cells.

Other features which are considered as characteristic for the invention are set forth in the appended claims.

Although the invention is illustrated and described herein as embodied in an energy and hydrogen transport system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic and partially sectioned view of a monoshell or monoshell hydrogen conduit of the invention.

FIG. 2 shows a schematic, partial and sectional view of duct variants.

FIG. 3 shows a schematic and partially sectioned view of a container for storing hydrogen.

FIG. 4 shows a schematic and partially sectioned view of two superimposed conduits that facilitate the conduction of hydrogen of the invention.

FIG. 5 shows a schematic, partial and sectional view of a variant of use of the ducts.

FIGS. 6 and 7 show schematized and sectioned views of an outer conduit and several internal hydrogen conduits.

FIG. 8 shows a schematic and partially sectioned view of a container for storing hydrogen.

FIG. 9 shows a flowchart of a hydrogen transfer system for electric power generation.

### DETAILED DESCRIPTION OF THE INVENTION

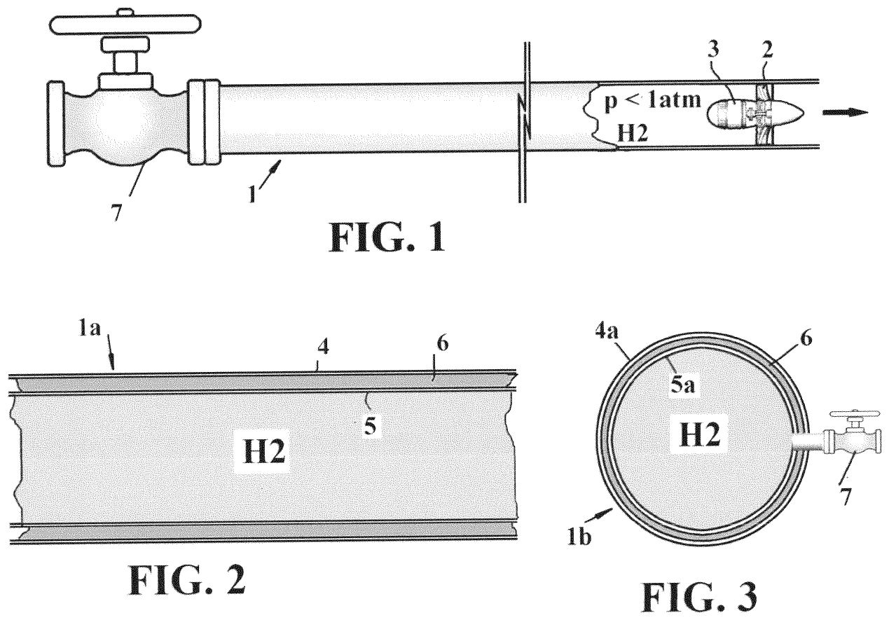

FIG. 1 shows an embodiment of the invention, consisting of the conduit (1) inside which hydrogen (H2) circulates at a pressure slightly below atmospheric, which is sucked from the end extraction for use by means of pumps, turbines or fans (2) driven by the electric motor (3), which automatically lowers the pressure in the duct. The stopcock (7) allows the cut off or opening of the passage of hydrogen. In the case of using pressurized ducts, it is also carried out with pumps, fans or fans placed at the other end. In this case, the double-walled conduit should be used, like the one shown in FIG. 2, creating the most pressurized external chamber that prevents the escape of hydrogen.

FIG. 2 shows a double-walled conduit (1a), the external wall (4) and the internal (5), between which carries nitrogen, noble gas or mineral oil (6) at a pressure higher than that of hydrogen, the which circulates through the internal canal.

Replace the paragraph between lines 4-7 on page 4 of the specification with the following: FIG. 3 shows the double-walled container or cylinder (1b), the external wall (4a) and the internal (5a), between which carries nitrogen, noble gas or mineral oil (6) at a pressure higher than that of hydrogen. The stopcock (7) allows the manual cutting or passage of hydrogen.

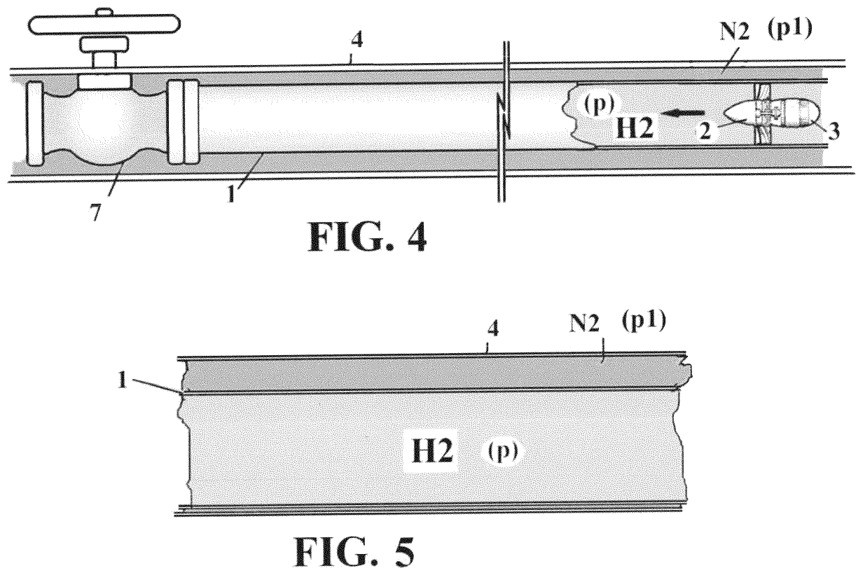

FIG. 4 consists of the conduit (1) through which hydrogen (H2) circulates at a pressure (p) several times greater than atmospheric pressure, which is surrounded by the conduit (4). Between the two, a chamber is created to which a noble gas or nitrogen is applied at a pressure (p1) slightly higher than that of the internal hydrogen chamber. The electric motor (3) drives the pump or compressor (2) that drives the hydrogen. The manual stopcock (7) allows the cutoff or opening of the passage of hydrogen that can be replaced by an electro valve.

FIG. 5 shows the conduit (4) inside which carries the conduit (1) with the pressurized hydrogen (p) and between both produce a chamber that carries N2 at pressure (p1). where is p1>p. Using two conduits or casings, in one, the innermost one, carries the pressurized hydrogen and is inside a second conduit or casing with a larger section which surrounds it, between both conduits or casings a noble gas or nitrogen is applied to greater pressure than that of the hydrogen in the conduit or internal chamber, which acts as a screen or insulator preventing the hydrogen from escaping. It is shown as a typical shape in which the internal canal rests internally on the external.

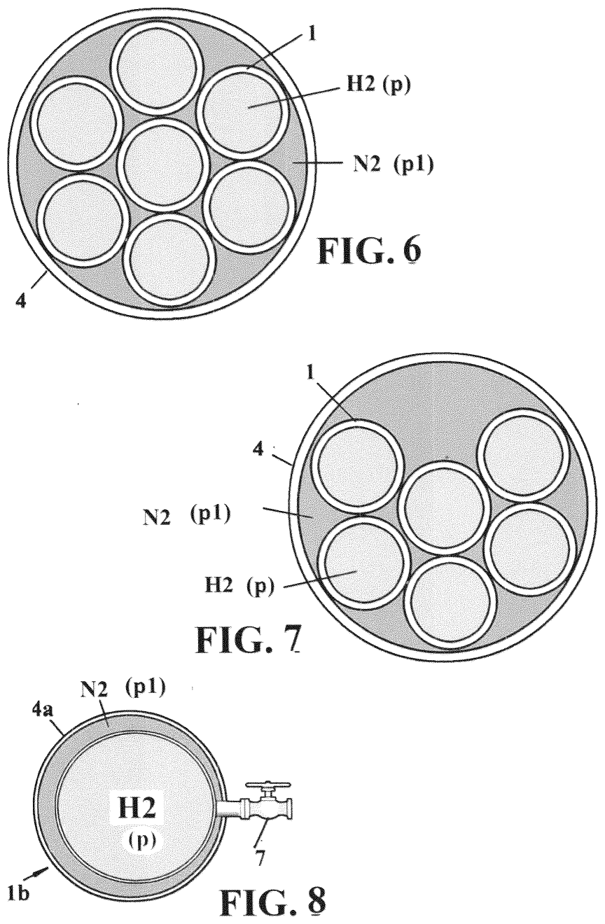

FIG. 6 shows the interior ducts (1) carrying hydrogen at pressure (p), which are covered or surrounded by the larger duct (4), which are separated from each other by a noble gas or nitrogen at the pressure (p). intermediate chamber pressure (p1) greater than the pressure of hydrogen. Where p1>p.

FIG. 7 shows the interior ducts (1) carrying hydrogen at pressure (p), which are covered or surrounded by the larger duct (4), which are separated from each other by a noble gas or nitrogen at the pressure (p). pressure (p1). Where p1>p. It differs from FIG. 3 in that the ducts (1) are resting on the lower part of the larger duct (4). In the event that the weight of the ducts is lower, they would be attached to the upper internal zone of the duct.

FIG. 8 shows the container or cylinder (1b), with the external cover (4a) and inside which there is another chamber that contains H2 at pressure (p). Between the chamber and the cover, a N2 gas is applied at the pressure (p1), where p1>p, which prevents the escape of hydrogen. The key (7) allows the manual cutting or passage of hydrogen.

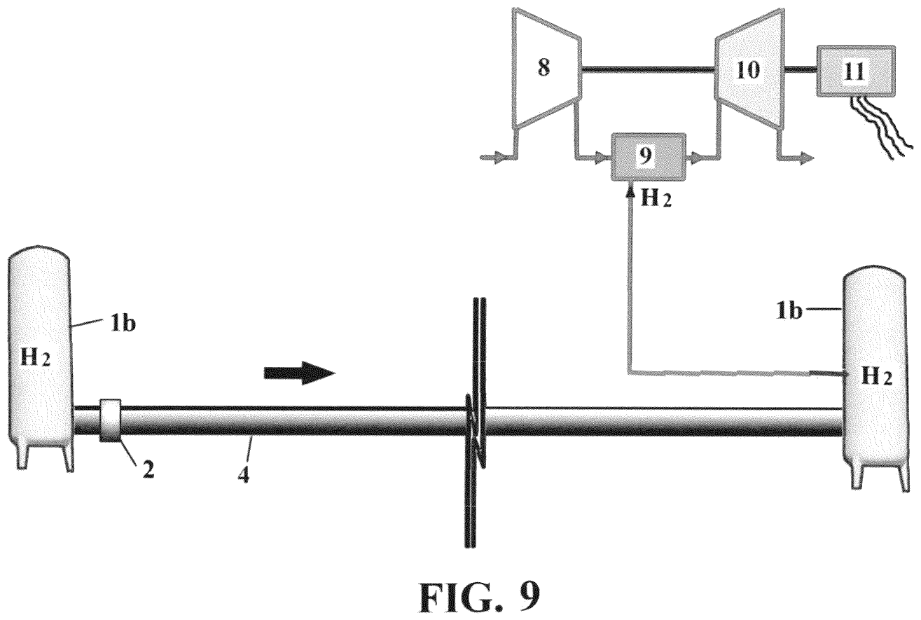

FIG. 9 shows the transfer between hydrogen tanks (4a) by means of the pump or compressor (2) and the conduit (4). Subsequently, from the receiving tank, the combustion chamber (9) of the gas turbine is fed. The latter is formed by the compressor (8) that sends the compressed air to the combustion chambers (9) where the combustion of hydrogen is produced by means of a spark, and combustion is subsequently maintained continuously. Applying the expansion of the gases to the turbine (10) whose axis, in addition to moving the compressor (8), drives the alternator (11).

1. An energy and hydrogen transport system comprising:
a duct for transferring hydrogen, said duct having a pump or fan driven by an electric motor for pressurizing or creating a vacuum therein;
a double walled container for storing hydrogen.

2. The system according to claim 1, wherein the duct is single walled and the pump or fan is disposed at an extraction end of said duct for transporting the hydrogen with a pressure below atmospheric.

3. The system according to claim 1, wherein said duct has two walls that define an intermediate chamber, said two walled duct for hydrogen at pressures (p) of several atmospheres in said double walled container or in said two-walled duct, said intermediate chamber carries a fluid, oil mineral, nitrogen or noble gas at a pressure (p1) higher than the pressures of hydrogen in said two walled duct.

4. The system according to claim 1, further comprising:
a conduit;
said duct is a plurality of ducts disposed within said conduit, said conduit defining a chamber containing a medium for surrounding said ducts, said medium having a pressure greater than the pressure of the hydrogen in said ducts.

5. The system according to claim 4, wherein said double walled container is two double walled containers spaced apart from one another, said duct connects said two double walled containers for transporting hydrogen therebetween.

6. The system according to claim 5, wherein one of said double walled containers is a receiving container, and hydrogen from said receiving container feeds a gas turbine to drive an electric generator or alternator for distribution of current to towns or industrial areas.

7. The system according to claim 1, wherein said container is constructed as a carboy.

8. The system according to claim 1, wherein said duct and double walled container are covered or lined with anticorrosive insulating layers.

9. The system according to claim 1, wherein said duct and container are selected from steels or polymers, reinforced with carbon and glass fibers, sheets or crossed bands of Kevlar or carbon nanotubes, epoxy with aluminum plates, aluminized or blued.

10. The system according to claim 1, wherein the materials for the container and duct are selected from carbon, austenitic, ferritic steels, steels with copper, brass, chromium and molybdenum alloys, copper bronze alloys with aluminum, tin, manganese, lead and silica, and with alloys of copper bronzes with nickel, or steels with microalloys.
